(19) United States
(12) Patent Application Publication
(10) Pub. No.: US 2008/0279406 A1
(43) Pub. Date: Nov. 13, 2008

(54) Portable Speaker Device

(75) Inventor: Guido Odilon Maurits D'Hoogh, Dendermonde (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/599,995

(22) PCT Filed: Apr. 13, 2005
(86) PCT No.: PCT/IB05/51213

§ 371 Date: Oct. 17, 2006

(30) Foreign Application Priority Data
Apr. 20, 2004 (EP) 04101618.9

(51) Int. Cl. H04R 1/28; H04R 1/02

(52) U.S. Cl. 381/332; 381/387; 181/199

(57) ABSTRACT

A portable speaker device comprising a front mounting plate (1) having two openings (1a, 1b) for sound transmission, two loudspeakers (3a, 3b) each fixedly secured to the front mounting plate for broadcasting through one of the openings, a rear mounting plate extending parallel to the front mounting plate (5), and two enclosure bodies (7a, 7b). These bodies are each formed by a plurality of separate ring-shaped enclosure members (11a₁-11a₅; 11b_{1′}-11b₅) axially movable with regard to each other. The members of each enclosure body have a front member (11a_{1′}; 11b₁) secured to the front mounting plate in surrounding relation to one of the loudspeakers and a rear member (11a₅; 11b₅) secured to the rear mounting plate. In a non-operational position of the speaker device, the mounting plates extend closely to each other, whereby the enclosure bodies have a collapsed shape and the device is very compact. In an operational position of the speaker device the mounting plates extend at a distant to each other, wherein the enclosure bodies have an extended shape and form sound cabinets (13a; 13b).

The invention relates to a speaker device, particularly a portable device, which is suitable as an accessory to a portable computer, a portable CD and/or DVD player or the like.

U.S. Pat. No. 5,082,084 discloses a sound case which comprises a speaker attached to a mounting board and an extensible sound chest assembly. The mounting board is provided with a central hole for sound wave transmission. The speaker surrounds this hole and extends in a tubular main body of the sound chest assembly, which body is attached to the mounting board. The sound chest assembly comprises three hollow tubular telescopic members which are slidably telescopic with each other and which have retracted positions within the main body and extended positions outside the main body. One of these telescopic members, viz. the member which is in its extended position most remote from the main body, is provided with a flange forming a closed bottom and provided with a pull ring. The telescopic members are provided with lugs and guide grooves cooperating therewith during movements of the members into and out of the main body. In an extended position the main body and the telescopic members form a resonant sound enclosure.

The known sound case is suitable for applications where mono audio is desired. However, if stereo sound is required the known device is inadequate.

For this reason it is an object of the invention to provide a compact portable speaker device of the kind mentioned in the opening paragraph, which device is able to reproduce stereo sound.

This object is achieved with the speaker device according to the invention which comprises a front mounting plate having two openings for sound transmission, two loudspeakers each fixedly secured to the front mounting plate for broadcasting through one of the openings, a rear mounting plate extending substantially parallel to the front mounting plate, and two enclosure bodies, which are each formed by a plurality of separate ring-shaped enclosure members axially movable with regard to each other, of which members of each enclosure body a front member is secured to the front mounting plate in surrounding relation to one of the loudspeakers and a rear member is secured to the rear mounting plate, wherein in a non-operational position of the speaker device the mounting plates extend closely to each other, the enclosure bodies having a collapsed shape, and wherein in an operational position of the speaker device the mounting plates extend at a distant to each other, the enclosure bodies having an extended shape and each forming a sound cabinet.

Thus, the speaker device according to the invention has two parallel or practically parallel mounting plates, between which plates two collapsable and extractable enclosure bodies are sandwiched. During non-use of the device, e.g. during traveling, the enclosure bodies are in their collapsed conditions and the parallel mounting plates extend close to each other, resulting in a compact portable unit. During reproduction, the speaker device being electrically connected to a sound signal generating apparatus, such as a DVD player, a laptop or the like, the enclosure bodies are in their extracted positions and form resonant sound cabinets, the ring-shaped enclosure members being in coaxial positions. In this condition the speaker device according to the invention is able to provide high quality music reproduction and other types of complex audio reproduction. Due to the presence of two parallel mounting plates it is very easy to bring the device from the collapsed state into the extracted state or vice versa. Mutually displacing of the mounting plates in a direction perpendicular to the plates, i.e. along the axial axes of the enclosure bodies, suffices to change both enclosure bodies in a single movement. The rear mounting plate may have two apertures for sound transmission, which apertures are each surrounded by a rear member of an enclosure body. In each of these apertures a passive radiator may be provided. In certain applications the passive radiator may be replaced by a resonator port, which may be of a collapsible type.

It is to be noted that U.S. Pat. No. 5,550,921 discloses a stereo sound source for a portable computer, which source comprises two speaker units and a mixing chamber acoustically connected to both units. The speaker units have stiff enclosures which are rotatably mounted on the mixing chamber.

It is further to be noted that FR-A 2 650 295 discloses an audio device, particularly a disc player or a tape recorder, which is provided with two separate speakers, the speakers being pivotally mounted to lateral side walls of the audio device. Each of these speakers is provided with a telescopic enclosure.

A practical embodiment of the speaker device according to the invention has the characteristic feature that in the condition that the enclosure bodes have their collapsed shape, all of the enclosure members, apart from the front member or the rear member, of each of the enclosure bodies are positioned in the relevant front member and rear member, respectively. In this way a very slim and handy device is obtained in the portable condition. The thickness of the device is only determined by the thickness of the mounting plates and the thickness, i.e. the axial length, of the front members.

Another practical embodiment has the characteristic feature that in the condition that the enclosure bodies have their extended shape, all of the enclosure members of each enclosure body form together an airtight and rigid sound cabinet.

This embodiment has preferably the characteristic feature that each of the enclosure members has essentially the form of a truncated cone-shaped body having its top portion directed to one of the mounting plates and its bottom portion directed to the other mounting plate. In this embodiment the enclosure members are conical segments which form airtight seals with each other in the operational condition of the speaker device. In this condition the small periphery of a top portion exactly fits into the large periphery of a bottom portion. The cone-shaped bodies may have circular or more or less elliptical cross-sections. In a practical embodiment said top portion is directed to the rear mounting plate and said bottom portion is directed to the front mounting plate. An embodiment which is favorable, particularly as to sound quality, is described in claim 5.

It is another object of the invention to provide a speaker device of the kind described in the opening paragraph and having a collapsable and extendable enclosure body, which forms an airtight and rigid cabinet in the operational position of the speaker device with simple means.

This object is achieved by the portable speaker device according to the invention, which comprises a front mounting plate having an opening for sound transmission, at least one loudspeaker fixedly secured to the front mounting plate for broadcasting through the opening, a rear mounting plate extending substantially parallel to the front mounting plate, and an enclosure body, which is formed by a plurality of separate ring-shaped enclosure members which are axially displaceable with regard to each other, of which members a front member is secured to the front mounting plate in surrounding relation to the loudspeaker or loudspeakers and a rear member is secured to the rear mounting plate, wherein in a non-operational position of the speaker device the mounting plates extend closely to each other, the enclosure body being in a collapsed condition, wherein in an operational position of the speaker device the mounting plates extend at a distant to each other, the enclosure body being in an extended condition and forming a sound cabinet, and wherein the enclosure members have essentially the form of truncated cone-shaped bodies having their top portions directed to one of the mounting plates, preferably the rear mounting plate, and their bottom portions directed to the other mounting plate.

By applying the right inclination angles in the enclosure members of truncated form an absolute air tight and rigid sound cabinet is guaranteed in the extended state of the enclosure body, i.e. the operational condition of the speaker device. In this context, preferably each of the cone-shaped bodies has a conical wall which makes an inclination angle α with a plane parallel to the mounting plates which is lying in the range of 82 to 87 degrees, particularly 85 degrees.

In an embodiment two loudspeakers are surrounded by one and the same front member. In such an embodiment two loudspeakers cooperate with one and the same cabinet, i.e. the enclosure body in its extended position. By this feature the embodiment of the device as described in claim 7 is suitable for stereo reproduction. Alternatively, it is possible to apply two speaker devices according to the invention, each having only one loudspeaker, for reproducing stereo sound.

The loudspeakers applied in the speaker devices according to the invention may be full-range speakers. It may however be preferred, to enhance the sound quality, to make use of different kind of speakers. For this reason an embodiment of the speaker devices according to the invention may have the features as defined in claim 9. As an example a low- and mid-frequency loudspeaker in combination with a high-frequency speaker, particular a tweeter, is possible. In another example, a mid- and high frequency loudspeaker is combined with a low-frequency speaker, particularly a bass speaker. Another option is to provide the speaker devices according to the invention with a mid-frequency loudspeaker, a tweeter and a bass speaker.

It is to be noted that the portable speaker devices according to the invention are suitable for portable computer applications and other applications such as CD players and MPEG players, where high-quality sound reproductions, but small device dimensions are required.

With reference to the Claims it is to be noted that various characteristic features as defined in the set of Claims may occur in combination.

The above-mentioned and other aspects of the invention are apparent from and will be elucidated, by way of non-limitative example, with reference to the embodiments described hereinafter.

In the drawings:

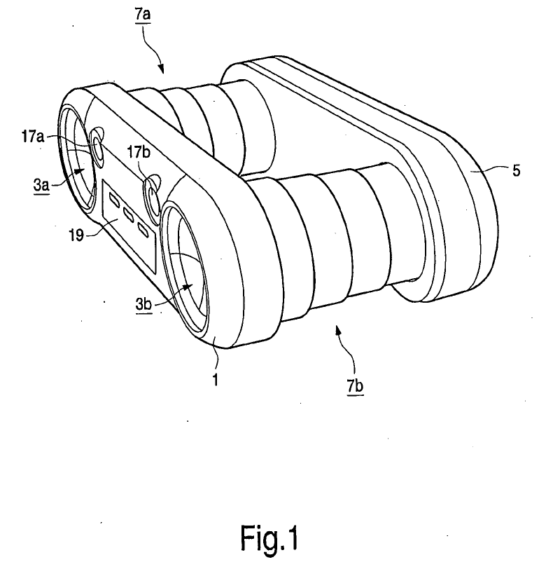

FIG. 1 is a perspective view of a first embodiment of the speaker devices according to the invention, in its operational position,

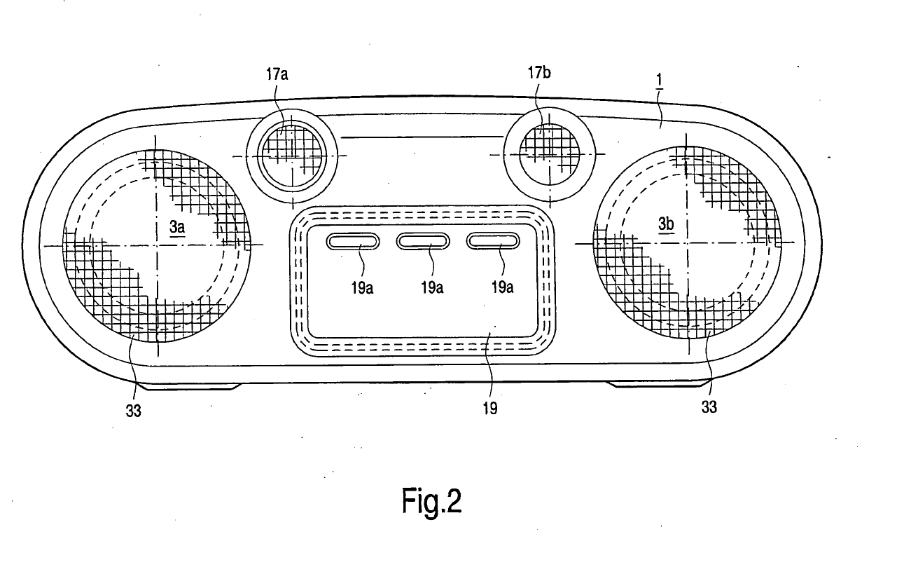

FIG. 2 shows the first embodiment in a diagrammatic front view,

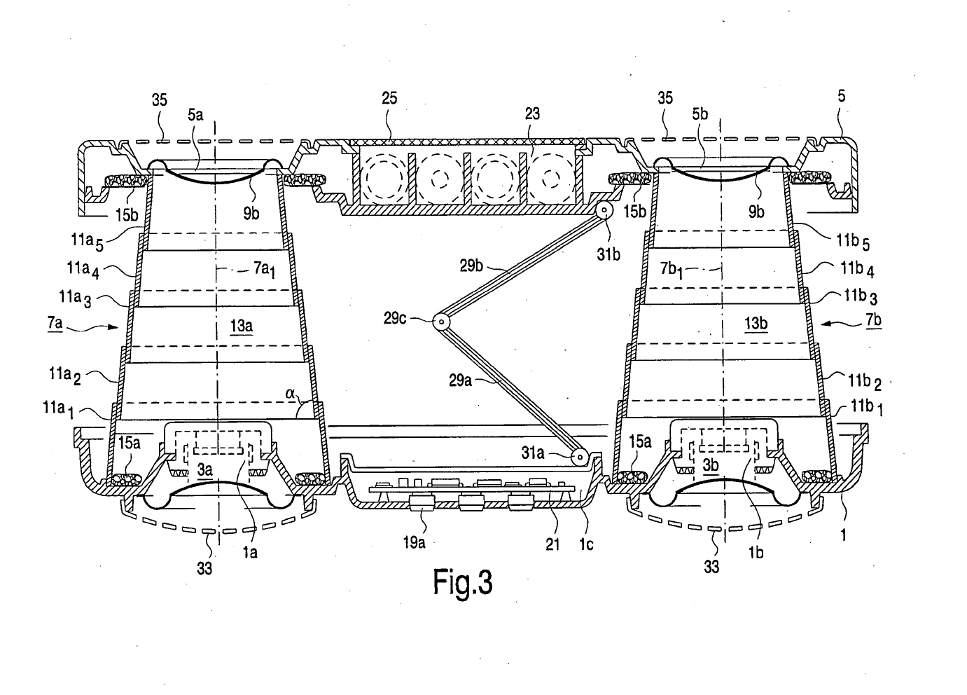

FIG. 3 shows the first embodiment in its operational position in a diagrammatic cross-section,

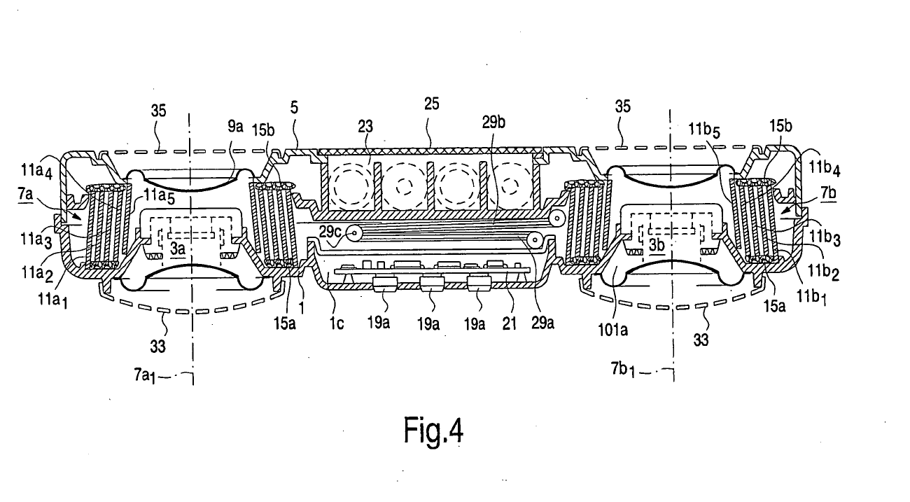

FIG. 4 shows the first embodiment in its non-operational position in a diagrammatic cross-section corresponding to the cross-section as depicted in FIG. 3,

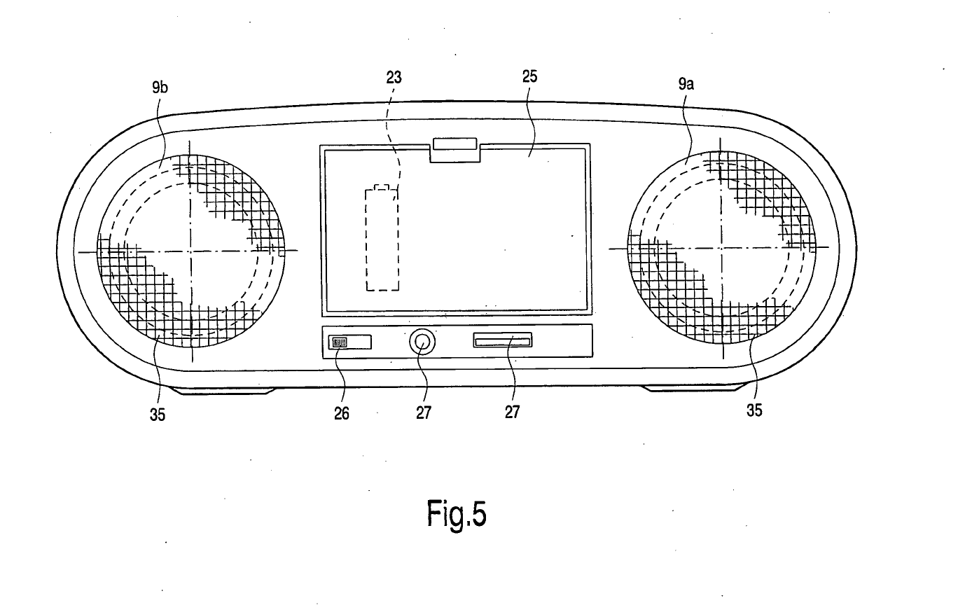

FIG. 5 shows the first embodiment in a diagrammatic rear view,

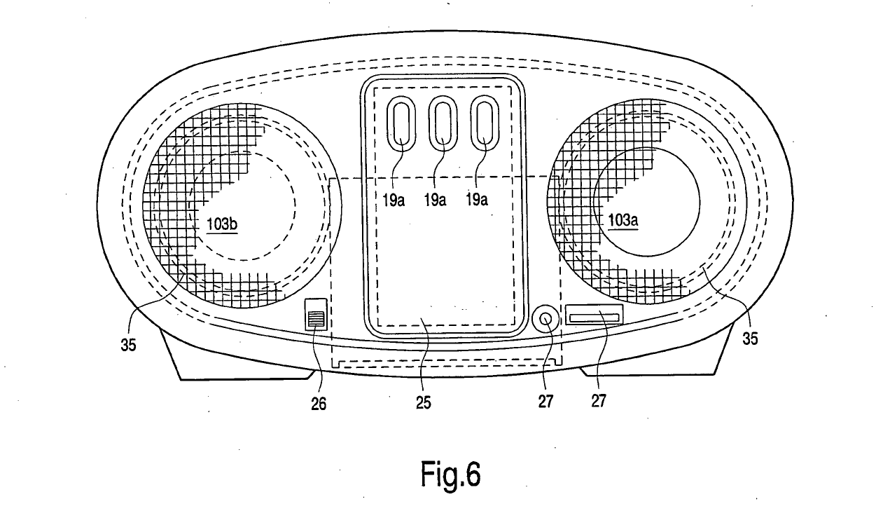

FIG. 6 shows a second embodiment of the speaker devices according to the invention in a diagrammatic front view,

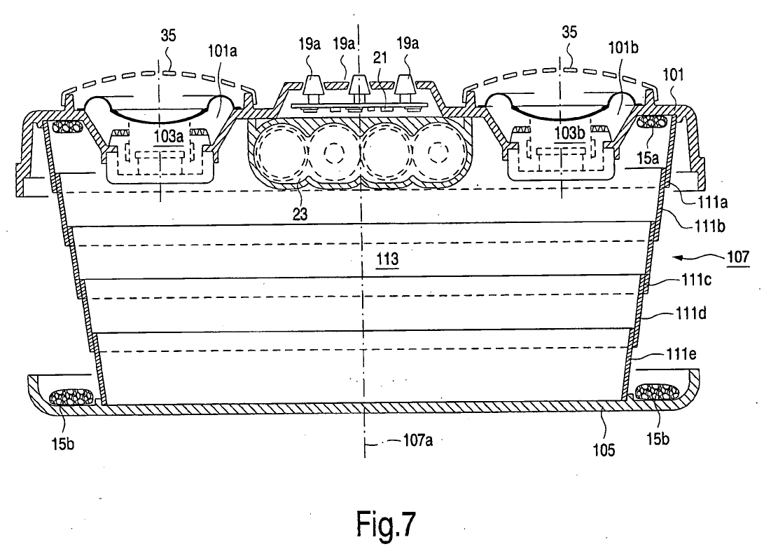

FIG. 7 shows the second embodiment in its operational position in a diagrammatic cross-section, and

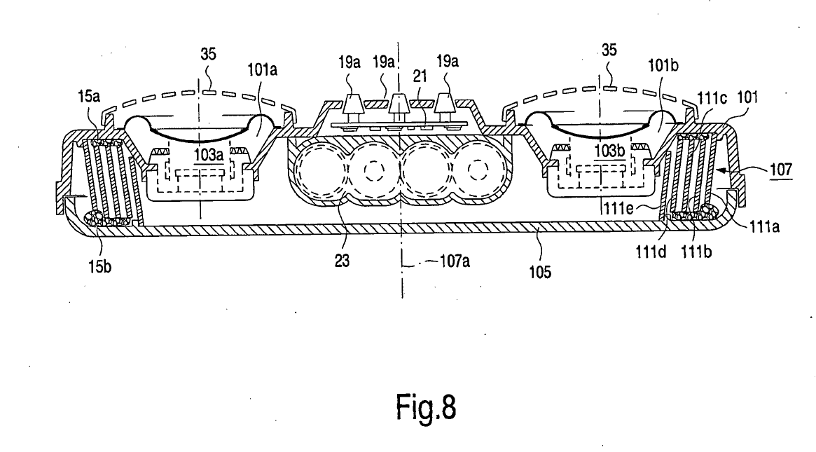

FIG. 8 shows the second embodiment in its non-operational position in a cross-section corresponding to the cross-section depicted in FIG. 7.

The portable speaker device according to the invention disclosed in the FIGS. 1 to 5 is provided with a front mounting plate 1, two loudspeakers 3a, 3b, a rear mounting plate 5 and two enclosures bodies 7a, 7b. The front mounting plate 1 has two openings 1a, 1b, also denoted in this paper as front openings, for sound transmission. The loudspeakers 3a, 3b which are mounted in the front openings 1a, 1b and secured to the front plate 1, may be known loudspeakers having e.g. an operational frequency range of 50 to 5000 Hz, i.e. woofers. Such loudspeakers, have a movably suspended diaphragm and an electromagnetic actuator for driving the diaphragm. The rear mounting plate 5 extends parallel to the front mounting plate 1 and is in this example provided with two apertures or openings 5a, 5b, also denoted in this paper as rear openings, for sound transmission. Two passive radiators 9a, 9b, are mounted in the rear openings 5a, 5b and secured to the rear plate 5. These passive radiators may be radiators known per se having e.g. an operational frequency range of 60 to 100 Hz. Such radiators have a movably suspended radiator body. Each of the enclosure bodies 7a, 7b comprises a number of separate enclosure members; in this example five enclosure members, denoted by 11a₁ to 11a₅; 11b₁ to 11b₅. These enclosure members are segments each having the form of a truncated cone-shaped body, the top portion, i.e. the portion near the smallest cross-section, being directed to the rear mounting plate 5, and the bottom portion, i.e. the portion near the largest cross-section, being directed to the front mounting plate 1. The enclosure members 11a₁ an 11b₁, also denoted in this paper as front members, are secured to the front mounting plate 1, e.g. by a suitable adhesive. The enclosure members 11a₅ and 11b₅, also denoted in this paper as rear members, are secured to the rear mounting plate 5, e.g. by a suitable adhesive. The enclosure members may be made from an injection moulded plastics, such as polysterene, ABS. Preferably a reinforced plastics is used. The front and rear mounting plates may be made from a similar material; however other materials, such as metal, e.g. aluminium, are possible.

In the in FIGS. 1 and 3 shown operational position of the speaker device, the two enclosure bodies 7a, 7b are in their extended form each creating a sound cabinet 13a, 13b. Due to the applied inclination angle α being in the range between 82 and 87 degrees the cabinets are solid and are airtightly sealed at the matching interfaces between the enclosure bodies.

In the in FIG. 4 shown non-operational position of the speaker device, the two enclosure bodies 7a, 7b are in their collapsed form. In this position the enclosure members of each set 11a₁-11a₅ and 11b₁-11b₅ are nested providing a very compact portable entity. In this embodiment the enclosure members 11a₂ to 11a₅ and 11b₂ to 11b₅ extend in this situation in the front members 11a₁ and 11b₁, respectively. In order to prevent rattling of the enclosure members in the non-operational state the device is provided with damping means, in this example in the form of a foam pads 15a and 15b, which are attached to the front mounting plate 1 and the rear mounting plate 5, respectively, in areas opposite at least the enclosure members 11a₂-11a₄ and 11b₁-11b₄. In the collapsed position of the enclosure bodies 7a, 7b these enclosure members are sandwiched and pressed between the pads 15a and 15b.

The speaker device can be brought from the non-operational position into the operational position or vice versa by moving the mounting plates 1 and 5 from each other and towards each other, respectively, along a moving axis parallel to the axial axis 7a₁, 7b₁ of the enclosure body 7a, 7b respectively. The axes 7a₁ and 7b₁ are oriented substantially perpendicular to the mounting plates 1, 5.

As particularly can be seen in the FIGS. 1 and 2 the depicted example of the speaker device according to the invention is provided with two additional speakers, viz. two tweeters 17a, 17b having an operational frequency range of 5 to 20 kHz. These tweeters 17a, 17b are mounted in the front mounting plate 1. The front mounting plate 1 is provided with a control panel 19 with buttons 19a, e.g. for volume, mute and LED's, and may be provided with a display panel. With reference to the FIGS. 3 and 4 it is noted that the front mounting plate 1 has a cavity 1c for accommodating electronic elements, such as a printed circuit board 21 with electronic components.

As particularly can be seen in the FIGS. 3, 4 and 5 the rear mounting plate 5 of the depicted example of the device according to the invention is provided with a battery compartments 23 covered by a lid 25. The compartment may be divided, as shown, into several sub-compartments. With reference to FIG. 5 it is noted that a switch 26 and connection elements 27, such as an USB, may be provided in the rear mounting plate, 5.

The embodiment depicted in the FIGS. 1 to 5 is provided with an electrical connection means which extends between the front mounting plate 1 and the rear mounting plate 5 in an area bordered by the plates 1 and 5 and by the enclosure bodies 3a and 3b. This electrical connection means, which serves to electrically connect the printed circuit board 21 with the battery compartment 23, comprises two more or less stiff cable portions 29a, 29b, particularly flat cable portions, which have a common central hinge body 29c. The cable portion 29a is attached to the front mounting plate 1 by means of a hinge elements 31a and the cable portion 29b is attached to the rear mounting plate 5 by means of a hinge element 31b. The applied electrical connection means may have a favorable effect on the stability of the construction formed by the mounting plates 1 and 5 and the enclosure bodies 7a and 7b, however the applied connection means is not an essential part. The device may further be provided with protective grids 33 and 35 for protecting the woofers 3a, 3b and the passive radiators 9a, 9b, respectively.

The portable speaker device according to the invention disclosed in the FIGS. 6 to 8 is provided with a front mounting plate 101, two loudspeakers 103a and 103b, a rear mounting plate 105 and an enclosure body 107 having a central axial axis 107a. The front mounting plate 101 has two openings 101a, and 101b for sound transmission, the loudspeakers 103a and 103b being fixedly secured to the front mounting plate 101 for broadcasting through the opening 101a and 101b, respectively. The rear mounting plate 105 extends substantially parallel to the front mounting plate 101. The enclosure body 107 is formed by a plurality of separate hollow ring-shaped enclosure members, in this example five members 111ₐ to 111ₑ, which are axially movably arranged with regard to each other. The enclosure members 111ₐ to 111ₑ are segments which each are cone-shaped and have a truncated top portion having a small periphery and being directed to the rear mounting plate 105 and a bottom portion having a large periphery and being directed to the front mounting plate 101. The enclosure member 111ₐ, in this paper also called a front member, is secured to the front mounting plate 101. The enclosure member 111_{d}, in this paper also called a rear member, is secured to the rear mounting plate 105. In an operational position of the speaker device, as depicted in the FIG. 7, the mounting plates 101 and 105 extend distantly to each other, the enclosure body 107 being in an extended condition and forming an airtight and rigid sound cabinet 113.

In a non-operational position of the loudspeaker device, as depicted in FIG. 8, the mounting plates 101 and 105 extend closely to each other—preferably the mounting plates touch each other—, the enclosure body 107 being in a collapsed condition and forming a compact portable unit. A locking device may be used for maintaining the collapsed condition.

The loudspeaker device shown in the FIGS. 6 to 8 may be provided, as far as applicable, with components, elements and details as used in the loudspeaker device described with reference to the FIGS. 1 to 5. These components, elements and details as far as present are indicated in the FIGS. 6 to 8 by the same reference signs as used in the FIGS. 1 to 5. The rear mounting plate 105 of the depicted second embodiment is a substantially flat plate. This means that battery compartment, switches, printed circuit board etc. are provided in and/or near the front mounting plate 101. This also means that an electrical connection means, such as the means 29a-29c, can be omitted. A construction with a flat rear mounting plate is also applicable into a variant of the first embodiment. The mounting plates 101 and 105 may be manufactured from the same materials as used for manufacturing the mounting plates 1 and 5. The enclosure members 111ₐ to 111ₑ may have the same inclination angle α as have the enclosure members applied in the first embodiment. The frequency range of the loudspeakers 103a and 103b may be the same as the frequency range of the loudspeakers 3a and 3b in this example the loudspeakers 103a and 103b are full-range speakers. Alternatively, an additional speaker and/or a passive radiator may be applied.

It is noted that the expression “mounting plate” in the terms front mounting plate and rear mounting plate should not be interpreted too strictly. In this paper it also means a plate-shaped or more or less plate-shaped mounting element or frame. It is also possible that the mounting plate is composed of more than one plate-shaped part or comprises other parts e.g. a cover plate.

It is also noted that the disclosed embodiments are only given as examples, although preferred embodiments. Nevertheless various alternatives as to shape, number of loudspeakers, number of enclosure bodies, number of enclosure members, etc. are possible within the framework of the invention. It is even possible to arrange the enclosure body or bodies in a reversed direction with regard to the mounting plates.

1. A portable speaker device comprising:
a front mounting plate having two openings for sound transmission,
two loudspeakers each fixedly secured to the front mounting plate for broadcasting through one of the openings,
a rear mounting plate extending substantially parallel to the front mounting plate, and
two enclosure bodies, which are each formed by a plurality of separate ring-shaped enclosure members axially movable with regard to each other, of which members of each enclosure body a front member is secured to the front mounting plate in surrounding relation to one of the loudspeakers and a rear member is secured to the rear mounting plate, wherein in a non-operational position of the speaker device the mounting plates extend closely to each other, the enclosure bodies having a collapsed shape, and wherein in an operational position of the speaker device the mounting plates extend distantly to each other, the enclosure bodies having an extended shape and each forming a sound cabinet.

2. A speaker device as claimed in claim 1, wherein in the condition that the enclosure bodies have their collapsed shape, all of the enclosure members, apart from the front member or the rear member, of each enclosure body are positioned in the relevant front member and rear member, respectively.

3. A speaker device as claimed in claim 1, wherein in the condition that the enclosure bodies have their extended shape, all of the enclosure members of each enclosure body form together an airtight and rigid sound cabinet.

4. A speaker device as claimed in claim 1, wherein each of the enclosure members has essentially the form of a truncated cone-shaped body having its top portion directed to one of the mounting plates and its bottom portion directed to the other mounting plate.

5. A speaker device as claimed in claim 1, wherein the rear mounting plate has two apertures for sound transmission, in each of which apertures a passive radiator is provided, and wherein the rear member of each enclosure body is arranged in surrounding relation to one of the passive radiators.

6. A portable speaker device comprising:
a front mounting plate having an opening for sound transmission,
at least one loudspeaker fixedly secured to the front mounting plate for broadcasting through the opening,
a rear mounting plate extending substantially parallel to the front mounting plate, and
an enclosure body, which is formed by a plurality of separate ring-shaped enclosure members which are axially movable with regard to each other, of which members a front member is secured to the front mounting plate in surrounding relation to the loudspeaker, and a rear member is secured to the rear mounting plate, wherein in a non-operational position of the speaker device the mounting plates extend closely to each other, the enclosure body being in a collapsed condition, wherein in an operational position of the speaker device the mounting plates extend distantly to each other, the enclosure body being in an extended condition and forming a sound cabinet and wherein the enclosure members have essentially the form of truncated cone-shaped bodies having their top portions directed to the one of the mounting plates and their bottom portions directed to the other mounting plate.

7. A speaker device as claimed in claim 6, wherein the number of loudspeakers is two.

8. A speaker device as claimed in claim 6, wherein in the extended condition of the enclosure body the enclosure members together form an airtight and rigid sound cabinet.

9. A speaker device as claimed in claim 1, wherein the two loudspeakers are mainly operable in a defined frequency range and wherein at least one additional audio reproducing means is provided, which is mainly operable in another frequency range.
